(19) United States
(12) Patent Application Publication
(10) Pub. No.: US 2012/0216232 A1
(43) Pub. Date: Aug. 23, 2012

(54) SET TOP BOX VIDEO STREAM MERGING/PASS THROUGH

(75) Inventors: Sherman (Xuemin) Chen, Rancho Santa Fe, CA (US); David Erickson, San Clemente, CA (US); Vladimir Silyaev, Laguna Niguel, CA (US); Alan Trerise, Los Gatos, CA (US); Marcus C. Kellerman, San Diego, CA (US)

(73) Assignee: BROADCOM CORPORATION, IRVINE, CA (US)

(21) Appl. No.: 13/115,035

(22) Filed: May 24, 2011

Related U.S. Application Data
(60) Provisional application No. 61/445,683, filed on Feb. 23, 2011.

(51) Int. Cl. H04N 7/173

(52) U.S. Cl. 725/109

(57) ABSTRACT

A gateway includes a communications interface and processing circuitry and establishes communications with at least one service provider device and with a serviced client device. The gateway receives serviced client device display structure instructions from a cloud server. The gateway then receives first streamed content from the cloud server, the first streamed content comprising images of an Internet session hosted by the cloud server and having a video program hole formed therein. The gateway receives second streamed content from the cloud server, the second streamed content comprising a video program corresponding to the video program hole of the first streamed content. Based upon the serviced client device display structure instructions, the gateway combines the first streamed content with the second streamed content to form merged streamed content and transmits the merged streamed content to the serviced client device. The client device may alternately receive and merge the video streams.

### CROSS-REFERENCE TO PRIORITY APPLICATION

This application claims priority under 35 U.S.C. §119(e) to U.S. Provisional Application Ser. No. 61/445,683 filed Feb. 23, 2011, which is incorporated herein by reference in its entirety.

### BACKGROUND OF THE INVENTION

1. Field of the Invention

The present invention relates generally to electronic devices; and more particularly to streamed content delivery from/to and Internet Access of electronic devices.

2. Description of the Related Art

Multimedia systems in the home and within other premises are often times serviced by cable Set Top Boxes (STBs), satellite system STBs, and Digital Subscriber Line (DSL) STBs. These STBs now often service Internet Browsing activities of serviced devices. These serviced devices may be televisions, DVD players, portable media players, video games, and other types of client devices. Serviced devices may also include high functionality devices such as desktop computers, laptop computers, tablet computers and other high processing capacity devices. The STBs service Internet Browsing sessions for all serviced devices, independent of their processing abilities. Some of these processing devices have just enough processing capacity to service a web browser. However, as is generally known, web browsers are susceptible to viruses, malware, and other destructive content that are injected into the device during the Internet Browsing sessions. Processing devices without sufficient processing capacity to run protection software will become easily infected by such destructive content. Once this destructive content has infected one client computer it may wreak havoc with all client devices on the client side of a servicing STB. Further, the processing requirements of some web browser processes may exceed the processing abilities of the serviced devices, causing the web browsing process to partially or fully fail.

### BRIEF DESCRIPTION OF THE DRAWINGS

FIG. 1 is a block diagram illustrating a system constructed according to one or more embodiments of the present invention;

FIG. 2 is a block diagram illustrating a system constructed according to one or more other embodiments of the present invention;

FIG. 3 is a flow chart illustrating operations according to one or more embodiments of the present invention;

FIG. 4 is a block diagram illustrating streamed video flow according to one or more embodiments of the present invention consistent with the operations of FIG. 3;

FIG. 5A is a flow chart illustrating operations according to one or more embodiments of the present invention;

FIG. 5B is a flow chart illustrating operations according to one or more embodiments of the present invention;

FIG. 6A is a flow chart illustrating operations for streamed video processing and merging consistent with the operations of FIGS. 1-5B;

FIG. 6B is a flow chart illustrating operations for processing and transmitting Internet Browsing session directions consistent with the operations of FIGS. 1-5B;

FIG. 7 is a block diagram illustrating a Set Top Box/Gateway constructed according to one or more embodiments of the present invention;

FIG. 8 is a block diagram illustrating a cloud server constructed according to one or more embodiments of the present invention; and

FIG. 9 is a block diagram illustrating a client device constructed according to one or more embodiments of the present invention.

### DETAILED DESCRIPTION

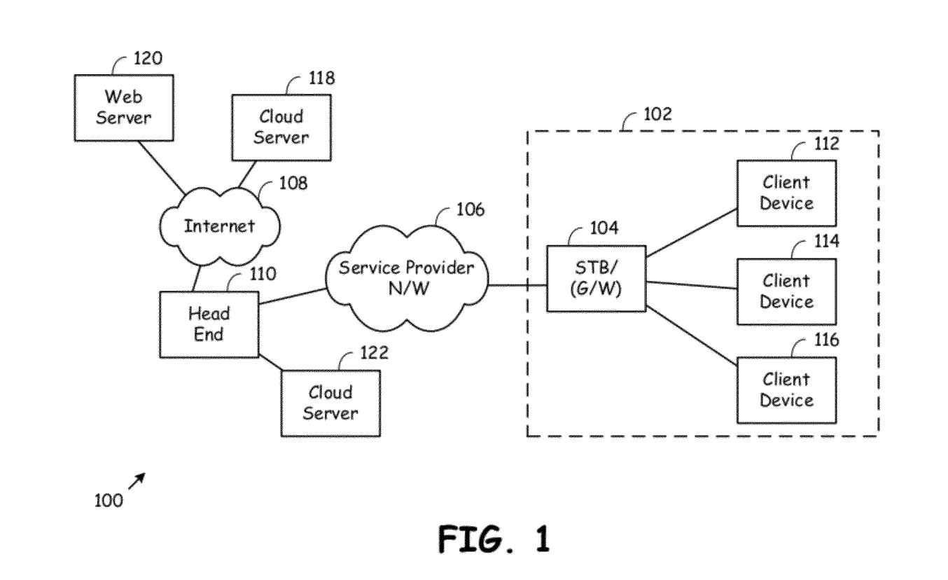

FIG. 1 is a block diagram illustrating a system 100 constructed according to one or more embodiments of the present invention. The system 100 is supported by an Internet Network 108 and includes a web server 120 coupled to the Internet 108, a cloud server 118 coupled to the Internet 108, a service provider head end 110 coupled to the Internet 108, a cloud server 122 coupled to the head end 110, and a service provider network 106 coupled to the head end. The service provider network 106 of FIG. 1 is one or more of a fiber network, a cable network, a telephone network, or another type network serviced by physical media.

A client site 102 includes a Set Top Box (STB) 104, referred to herein interchangeably as a Gateway (G/W), which services a plurality of client devices 112, 114, and 116 at a customer site, such as a home, office, or other customer setting. The client devices 112, 114, and 116 include one or more thin clients, the thin clients being televisions, video players, video game consoles, etc. The client devices 112, 114, and 116 may also include other devices that are not considered thin clients, such as desktop computers, laptop computers, tablet computers, etc. A thin client, as distinguished from a non-thin client, has limited processing capacity and limited memory.

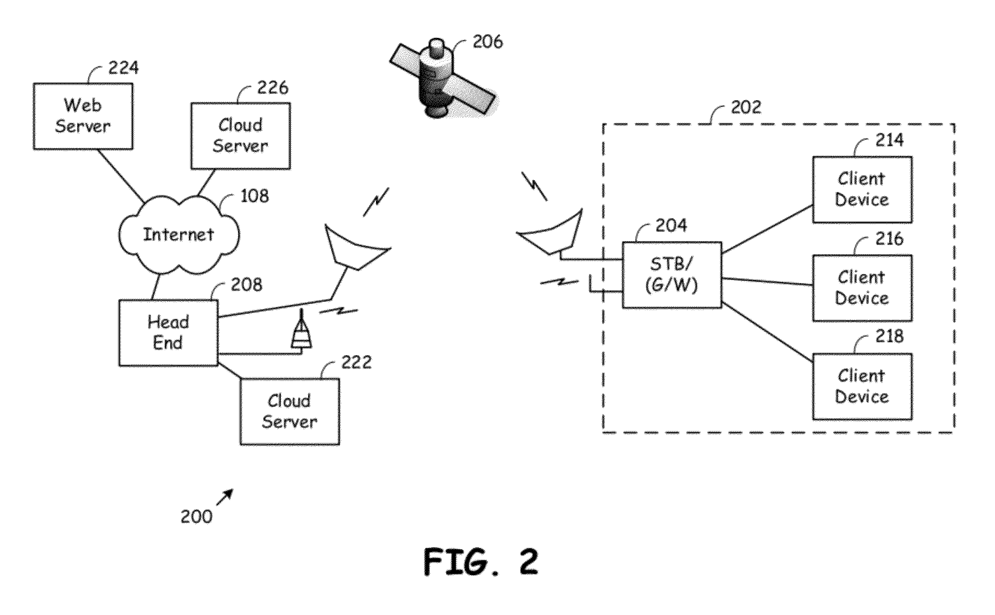

FIG. 2 is a block diagram illustrating a system 200 constructed according to one or more other embodiments of the present invention. The system 200 of FIG. 2 is similar to the system 100 of FIG. 1, except that a head end 208 communicates with a STB 204/Gateway via one or more wireless links, as contrasted to the wired links of FIG. 1. With the structure 200 of the system of FIG. 2, as well as the structure of FIG. 1, the STB 204 services a plurality of client devices 214, 216, and 218. The wireless link may be serviced by satellite dishes and convey communications between the head end 208 and the STB 204 via a satellite 206. Alternately, the wireless link may be serviced by a point to point wireless link, a Wireless Local Area Network (WLAN), a Wireless Wide Area Network (WWAN), or another type of wireless link, e.g., 60 GHz, etc.

STB 204 serves at least client device 214, 216, and/or 218 (Television, Personal Media Player, game console, laptop computer, desktop computer, palm computer, etc.). Each of the STB 204 and client devices 214, 216, and/or 218 may have limited resources for web browsing, e.g., processing of content contained in web pages to render experience to users. Some client devices 214, 216, or 218 may not be able to interact with web servers at all because of their reduced processing capabilities, i.e., not able to service a web browser application.

The STB 204 may have the ability to service web browsing for one or more of the client devices 214, 216, and/or 218 but may also be resource limited, e.g., memory, communications, and/or processing limited. A primary function of the STB 204 is to provide video service to the client devices. It cannot fail to provide this service while providing web browsing services to the client devices 214, 216, and/or 218. Thus, even though it may have the processing capabilities to service an Internet browsing session, it may not be able to service such Internet browsing session without interfering with its other processing requirements.

A cloud server 222 (or 226) couples to or is accessible to a head end 208 of the service provider. The cloud server 222 interacts with the STB 204 or client device 214, 216, and/or 218 via the STB 204 to remotely service web browsing session(s) for one or more of the client devices 214, 216, and/or 218. The cloud server 226 interacts with the STB 204 (via the head end 208) to interface with a user of a client device 214, 216, and/or 218 to receive user input, i.e., keypad input, cursor input, voice input, etc. The cloud server 222 or 226 supports at least a portion of a web browser session for a client device. The cloud server 222 or 226 produces a video stream (H.264, MPEG, AVC, etc.) that is streamed to the client device 214, 216, and/or 218 via the head end 208 and the STB 204.

By placing browser functionality in the cloud server 222 or 226, processing workload for the STB 204 and/or client devices 214, 216, and/or 218 is substantially reduced. Further, the cloud server 222 or 226 is better able to protect a client device 214, 216, and/or 218 and STB 204 from dangers associated with web browsing, e.g., IP service attack, malware, viruses, etc. Content that is available to the client devices 214, 216, and/or 218 may be limited by the cloud server 222 or 226.

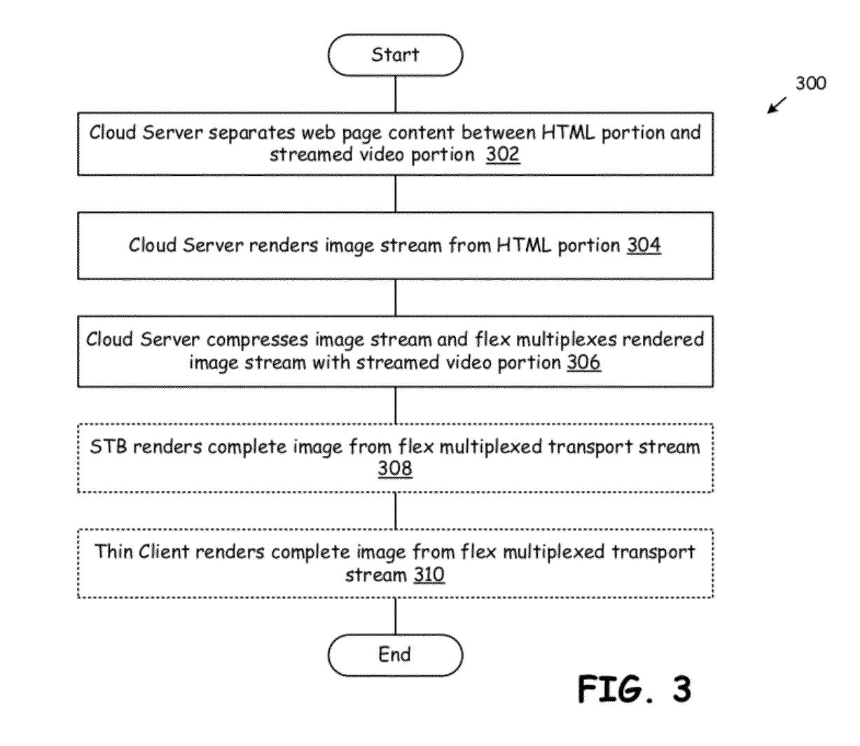

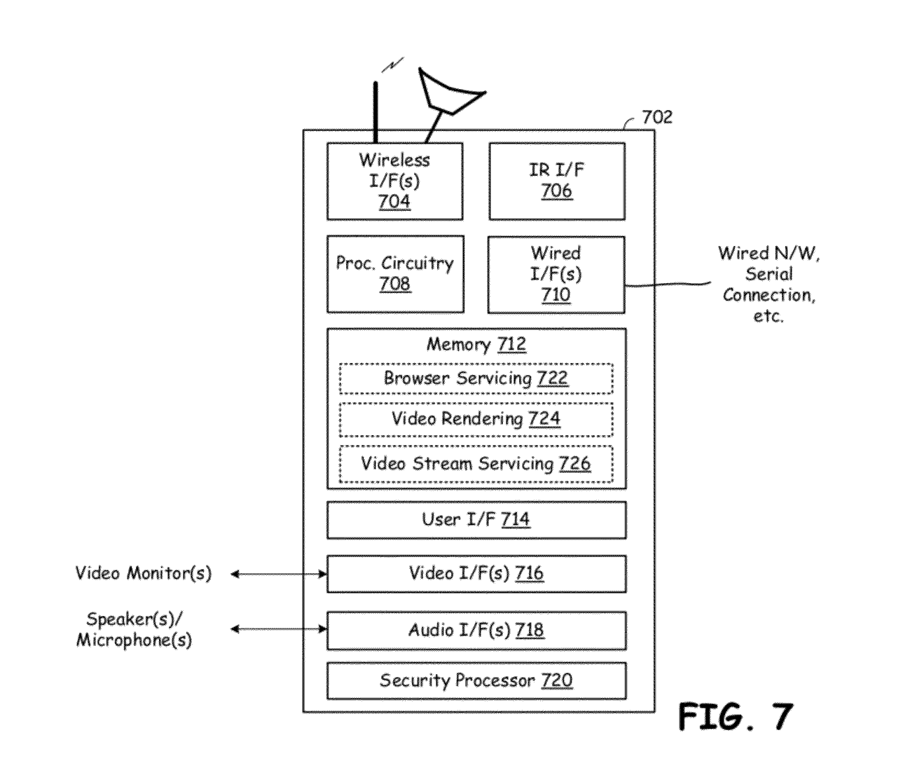

Referring jointly to FIGS. 1 and 2, the systems 100 of FIG. 1 and 200 of FIG. 2 support operations according to the flowcharts of FIGS. 3-6B and may include the structures of FIGS. 7-9. According to these operations, and referring particularly to FIG. 2, e.g., cloud server 222 hosts an Internet browsing session for a client device, e.g., 214. The Internet browsing session is hosted based upon Internet browsing instructions received from the serviced client device 214. The cloud server produces a video stream that represents the hosted Internet browsing session, which includes a first stream and a second stream. The first steam includes images of the Internet session hosted by the cloud server and has a video program hole contained therein, corresponding to a streaming video of the Internet browsing session, e.g., accessed video from a hosting web site, streaming video from a sporting event, etc. The second stream includes the video corresponding to the video program hole of the first stream.

Gateway 204 receives both the first video stream and the second video stream and forms a merged video stream based thereupon. The gateway 204 merges the first and second video streams such that the video program corresponding to the second video stream is placed into the video program hole of the first video stream. The STB 204 then it transmits the merged video stream to the client device 214. With another embodiment, the client device 214 receives both the first and second video streams and performs the merging. The client device 214 then presents the merged stream content to a user.

With the cloud server hosting the Internet browsing session, client device 214 is protected from the dangers associated therewith. Such dangers may include, for example, malware, viruses, and other content that the client device 214 may be unable to protect itself therefrom based upon processing and memory limitations. Likewise, the Internet browsing session being hosted by cloud server 222 may be done so if the STB 204 has insufficient processing or memory resources to host the Internet browsing session for client device 214.

FIG. 3 is a flow chart illustrating operations according to one or more embodiments of the present invention. With the operations 300 of FIG. 3, web page content has an HTML portion and H.264 portion (streamed video). The Cloud server separates the HTML portion from the H.264 portion (Step 302). The Cloud server renders images from the HTML portion (Step 304), compresses the rendered image and FlexMuxes the compressed rendered portion with the H.264 portion to create a combined transport stream having first streamed content and second streamed content (Step 306). Either STB (Step 308) or thin client (Step 310) renders a complete image from the transport stream that includes the H.264 portion and the compressed rendered portion. The rendered image is then presented on the thin client.

Still referring to FIG. 3, and with particular reference to FIG. 1, cloud server 118 separates web page content between the HTML portion and the streamed video portion at Step 302. In such case, the cloud server 118 hosts an Internet browsing session for client device 116, for example. This Internet browsing session is hosted by cloud server 118 because of processing and/or memory processing limitations of the client device 116, i.e. client device 116 is a thin device, thin client and STB/gateway 104 is unable to service the Internet browsing session for client device 116.

In such case, the Internet browsing session hosted by cloud server 118 includes preparation of a web page that includes an HTML portion and an H.264 portion. For example, when a user of client device 116 accesses a web page, such as a video service web page, a news service web page, or any other type of web page that presents video images via a web browser, the hosted web page by a cloud server 118 will include both an HTML portion and an H.264 portion (or a different type of stream content such as an MPEG, JPEG, or another video coding standard supported for framing within an HTML web page). Likewise, differing types of markup languages or other languages supporting web browsing may be employed other than the HTML language.

In such case, the cloud server 118 renders images from the HTML portion at Step 304 of FIG. 3 and compresses the rendered images of the HTML portion into a streamed video format. The HTML portion has a hole formed therein corresponding to the streamed video portion of the web page of the Internet browsing session hosted by the cloud server 118. Then, the cloud server 118 FlexMuxes the compressed video corresponding to the HTML portion along with the video portion of the web page and transmits such to the STB 104 via the Internet 108, the head end 110, and the service provider network 106.

Depending upon the particular operation, either the STB 104 or a thin client, e.g. 116, receives both the first video stream and the second video stream, renders each of these images into a format that may allow the first and second video streams to be combined, and produces a merged video stream. The merged video stream, when produced by the STB 104 may be re-encoded by the STB 104 and transmitted to the client device 116. Alternatively, the STB 104 may transmit the merged image into a format received by client device 116 for presentation. When the client device 116 performs the image receipt and generation, client device 116 would receive both the first and second streamed content corresponding to the hosted Internet browsing session and merge such images for later presentation by client device 116.

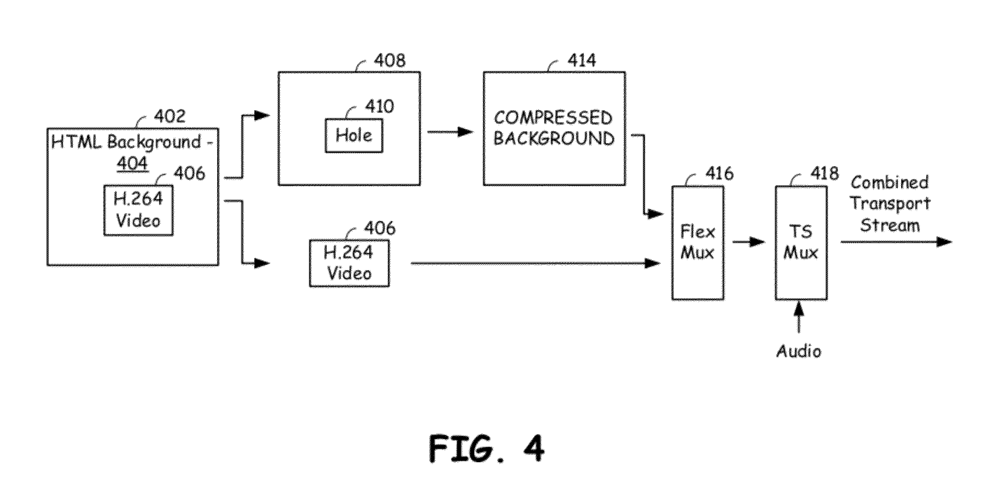

FIG. 4 is a block diagram illustrating streamed video flow according to one or more embodiments of the present invention consistent with the operations of FIG. 3. Referring to both FIG. 1 and to FIG. 4, cloud server 118 produces, based upon the hosted web Internet browsing session for client device 116, an HTML background 404 and the H.264 video 406. The H.264 video 406 would typically be received by the cloud server 118 based upon the HTML background 404 being produced in a web browsing session. In such case, the cloud server 118 produces first streamed content 408 that includes a video program hole 410 formed therein. The H.264 video 406 of the web page hosted by the cloud server 118 is not included in the first video stream 408, but is instead passed directly as second streamed content 412 to the STB. The first streamed content is encoded and compressed according to a video standard, e.g. MPEG, H.264, or another type of video format to produce the compressed background 414. FlexMux 416 is an operation that is performed either by STB 104 or by a serviced client device 116. In such case, the FlexMux 416 operation, which is a logical representation of video processing operations, receives both the compressed background 414, which is the first streamed content, and the H.264 video content 406, which is the second streamed content. The FlexMux 416 merges the first streamed content with the second streamed content based upon serviced client device display structure instructions received from the cloud server 118. The serviced client device display structure instructions received from the cloud server 118 indicate the format of the first and second streamed content and the manner in which the first and second streamed content are to be merged to form merged streamed content. The output of the FlexMux 416 is passed to a TSMux 418 that may introduce an audio program into the merged streamed content. The merged streamed content is then transferred as a combined transport stream to client device 116 for presentation by client device 116.

The FlexMux 416 and TSMux 418 of the process/structure of FIG. 4 may be embodied within the STB 104 and/or client device 116 of the system 100 of FIG. 1. The operation of these components would be slightly different based upon the location of their instantiation, as would the communication path of the first streamed content and second streamed content from the cloud server 118 to client device 116.

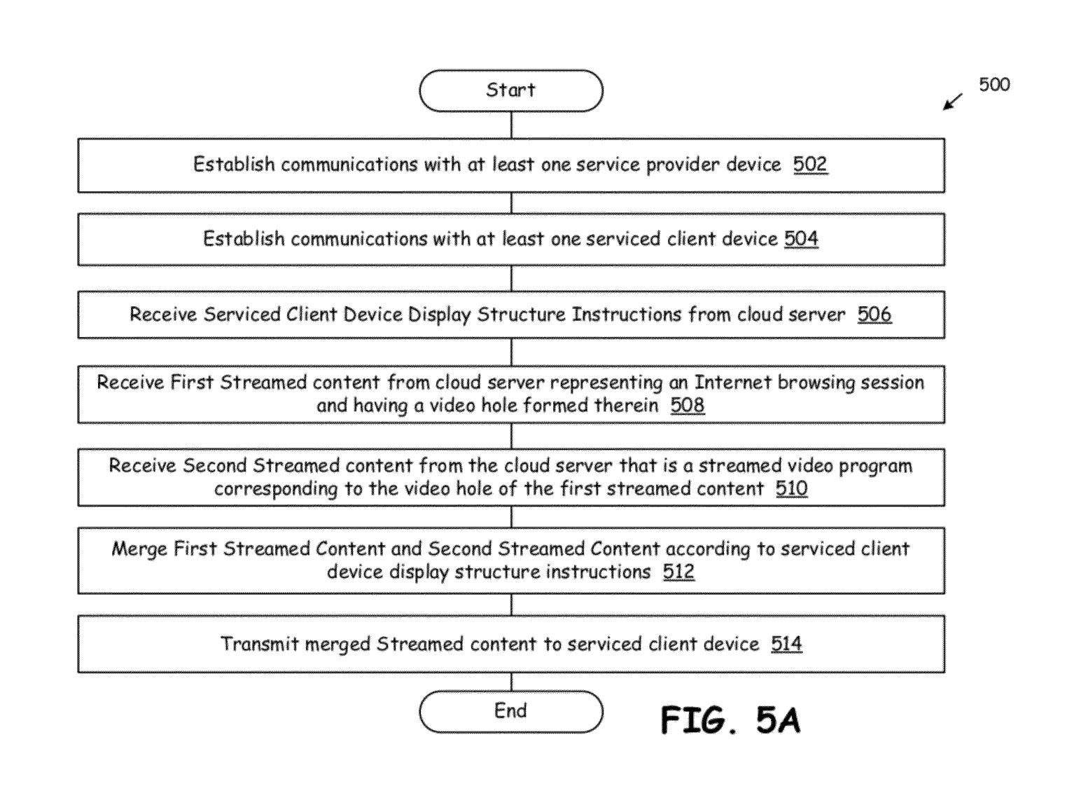

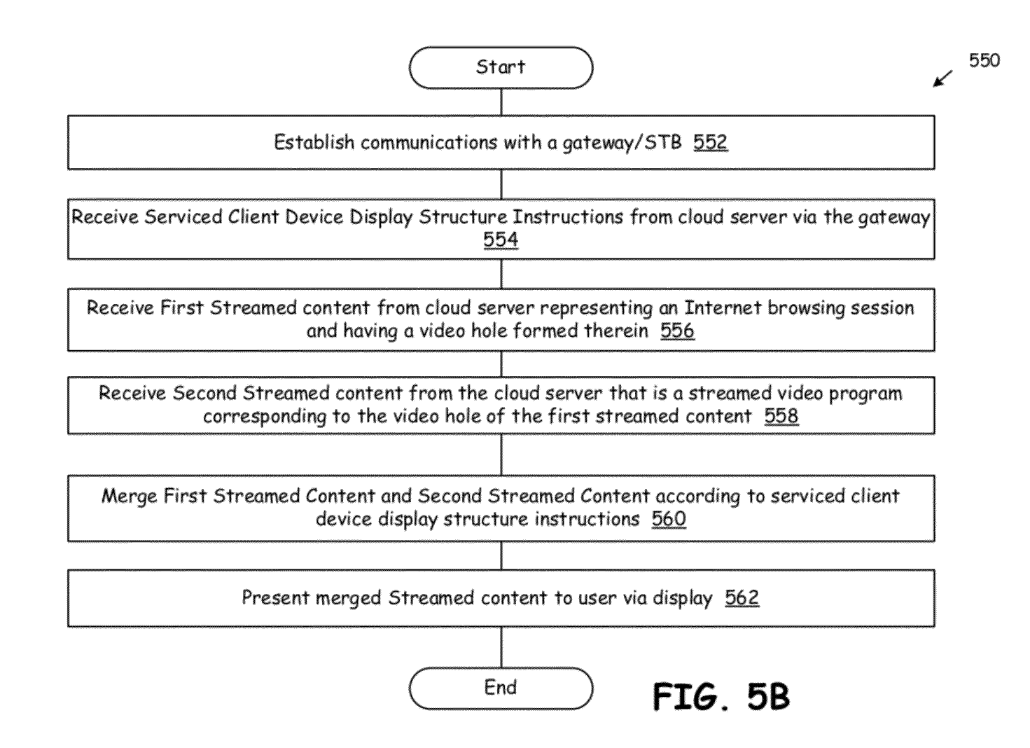

FIG. 5A is a flow chart illustrating operations according to one or more embodiments of the present invention. The operations 500 of FIG. 5A commence with the STB 104 establishing communications with at least one service provider device (Step 502). The communications of STB 104 would be established with head end 110, cloud server 118, cloud server 122, and/or web server 120. Operations continue with the STB 104 establishing communications with at least one serviced client device (Step 504). Serviced client devices would include client device 112, 114, and/or 116. The processing capabilities of each of the client devices 112, 114, and/or 116 would typically differ based upon their construct. For example, one of the client devices 112 may be a desktop computer, while another client device 114 is a television, a digital video disc player, and client device 116 may be a gaming console. Thus, each of client devices 112, 114, and 116 would have differing processing capabilities. In such case, based upon the differing processing capabilities, one of client devices 112, 114, and 116 would have its Internet browsing sessions hosted by cloud server 118. Such would be performed to protect client device 112, 114, or 116 from the dangers of Internet browsing operations.

The operations 500 of FIG. 5A continue with the STB 104 receiving serviced client display structure instructions from the cloud server 118 (Step 506). The STB 104 then receives first streamed content from the cloud server 118 representing an Internet browsing session serviced for client device 116 and having a video hole formed therein (Step 508). The STB 104 then receives second streamed content from the cloud server 118 that is a streamed video program corresponding to the video hole of the first streamed content (Step 510). The second streamed content in some embodiments is actually streamed video that is accessed at the Internet browsing session of the cloud server 118 that is serviced for client device 116. In such case, the second streamed content is simply passed through by the cloud server 118 to the STB 104 Likewise, the first streamed content includes a streamed image representation of the remainder of the Internet browsing session hosted by cloud session 118.

Operation continues with the STB 104 merging the first streamed content and the second streamed content according to the serviced client device display structure instructions (Step 512). The merged streamed content is then transmitted to the serviced client device 116 for subsequent presentation to a user of the serviced client device (Step 514). From Step 514, operation 500 of FIG. 5A ends.

FIG. 5B is a flow chart illustrating operations according to one or more embodiments of the present invention. The operations 550 of FIG. 5B will be described jointly with reference to FIG. 2 and FIG. 5B. The operations 550 of FIG. 5B commence with a serviced client device 216 establishing communications with an STB/gateway 204 (Step 552). The serviced client device 216 then receives serviced client device display structure instructions from a cloud server 222 that is hosting an Internet browsing session (Step 554). The serviced client device display structure instructions are received from the cloud server 222 via a communications path that includes the head end 208, wireless link service via satellite 206, and the STB/gateway 204.

Operation continues with the serviced client device 216 receiving first streamed content from the cloud server 222 that represents an Internet browsing session serviced by cloud server 222 and having a video hole formed therein (Step 556). Operation continues further with a client device 216 receiving second streamed content from a cloud server 222 that is a streamed video program corresponding to the video hole of the first streamed content (Step 558). The client device 216 then merges the first streamed content and the second streamed content according to the service client display structure instructions (Step 560). Then, the serviced client device 216 presents the merged stream content to a user via display of the serviced client device (Step 562). From Step 562 the operations of FIG. 5B conclude.

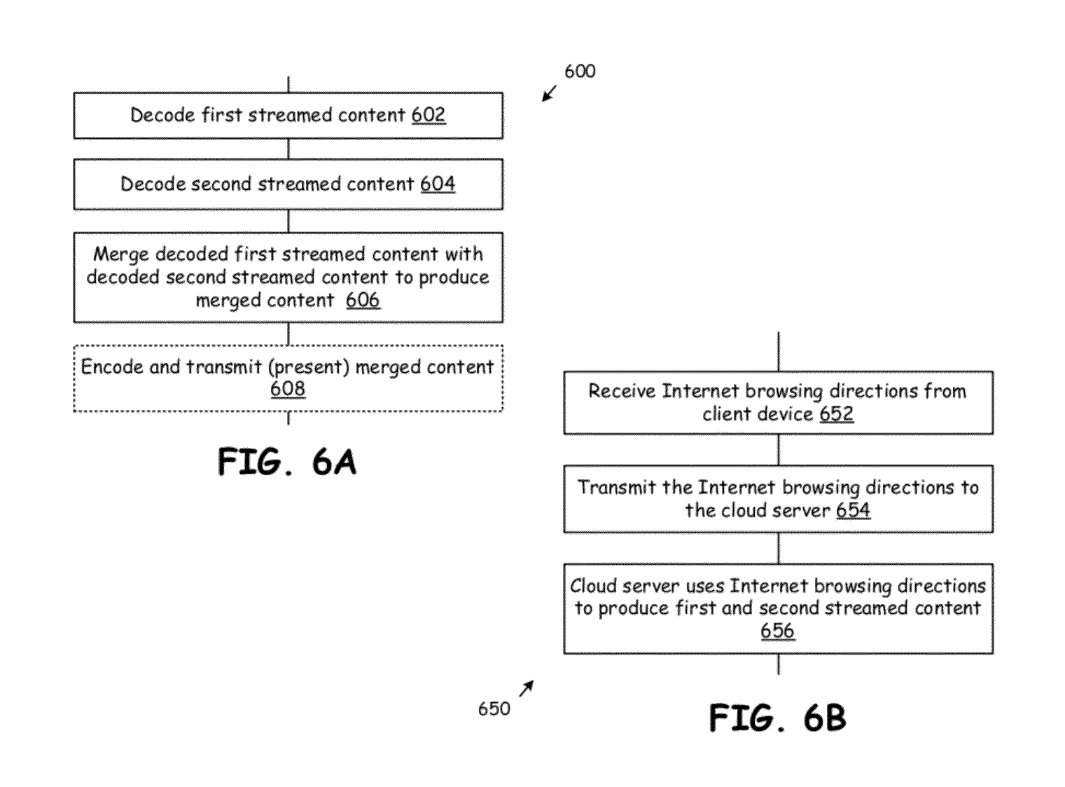

FIG. 6A is a flow chart illustrating operations for streamed video processing and merging consistent with the operations of FIGS. 1-5B. The operations 600 of FIG. 6A commence with the STB 104 or serviced client device 216, or other components, decoding the first streamed content (Step 602). The first streamed content may be encoded according to the mpeg and coding standard, H.264 encoding/decoding standard, or another encoding/decoding standard. Operation continues with the STB 104 or serviced client device 216 decoding the second streamed content (Step 604). The first streamed content and the second streamed content may be encoded according to a differing encoding standard. Further, the first streamed content and second streamed content may be encoded according to a consistent or same video coding standard. Operation continues with the STB 104 or serviced client device 216 merging decoded first streamed content with a decoded second streamed content to produce the merged content (Step 606).

The first streamed content and the second streamed content are merged by the STB 104 or serviced client device 216 according to the serviced client device display structure instructions. In short, the serviced client device display structure instructions direct the STB 104 or serviced client device 216 where to insert the second streamed content into the first streamed content to produce the merged content. Next, the STB 104 may encode and transmit the merged content to a serviced client device, e.g. serviced client device 116 (Step 608). However, when the operation 600 of FIG. 6A are performed by a serviced client device 216, the Step 608 would not be performed.

FIG. 6B is a flow chart illustrating operations for processing and transmitting Internet Browsing session directions consistent with the operations of FIGS. 1-5B. The operations 650 of FIG. 6B commence with an STB 104 receiving Internet browsing directions from a serviced client device (Step 652). As was previously described, a cloud server 118, for example, services an Internet browsing session for a client device when the client device or STB does not have the capability or processing resources to service the Internet browsing session. When servicing the Internet browsing session for the serviced client device, cloud server 118 provides representation of a browsing interface to a user of the client device via the streamed video provided to the client device by the cloud server 118. A user of the client device then provides his or her input back to the cloud server 118 via mouse, keyboard, or another type of input. Because the client server is actually hosting the Internet browsing session, the user input is simply transmitted to the cloud server 118 hosting the Internet browsing session via a servicing STB and communications path. Thus, the STB transmits the Internet browsing directions to the cloud server 118 (Step 654).

The cloud server 118 then uses the Internet browsing directions to produce the first and second streamed content (Step 656). For example, the user may type in the address of a web page that he or she desires to browse. The cloud server 118 uses the web address received from the client device to initiate an Internet browsing session at that particular website. The cloud server 118 then produces a video stream representing that Internet browsing session. However, the user of the client device cannot access any of the content of the web page directly because the serviced client device does not host a browser which instantiates or services the Internet browsing session. In such case, therefore, any user input must be relayed back to the cloud server 118 for further Internet browsing session operations. Thus, the operations 650 of FIG. 6B represent such relay of input from a user of a serviced client device back to the cloud server for use in hosting the Internet browsing session.

FIG. 7 is a block diagram illustrating a Set Top Box/Gateway 702 constructed according to one or more embodiments of the present invention. The STB 702 of FIG. 7 includes a wireless interface 704, an infrared interface 706, processing circuitry 708, one or more wired interfaces 710, and memory 712. The STB 702 typically would also include a user interface 714, at least one video interface 716, at least one audio interface 718, and may include a security processor 720. The wireless interfaces 704 support wireless communications with one or more wireless networks, including WLAN networks, WPAN networks, WWAN networks, satellite networks, and may also support communications with wireless serviced client devices. This wireless interface 704 may service communications consistent with cellular network standards, WPAN standards such as the Bluetooth standard, WLAN standards as IEEE 802.11x standards, WWAN standards such as the WiMAX standard, and/or another type of wireless communication standards. The IR (Infrared) interface 706 supports IR communications with remote controls and client devices. The IR communications may support an industry standard or proprietary communications protocol.

The processing circuitry 708 may include one or more of a system processor, a digital signal processor, a processing module, dedicated hardware, an application specific integrated circuit (ASIC), or other circuitry that is capable of executing software instructions and for processing data. The memory 712 may be RAM, ROM, FLASH RAM, FLASH ROM, optical memory, magnetic memory, or other types of memory that is capable of storing data and/or instructions in allowing processing circuitry to access same. The wired interfaces 710 may include a DSL interface, a USB interface, a fire wire interface, a serial interface, a parallel interface, an optical interface, or another type of interface supported by a media that is copper, metal, or optical.

The user interface 714 may include keypad, video display, cursor control, touch pad, or other type of interface that allows a user to interface with the STB 702. The video interface 716 couples the STB 702 to one or more video monitors. The communications link between the video interface 716 and the video monitor(s) may be an HDMI interface, a composite video interface, component video interface, an S-video interface, or another type of video interface supported by both the video monitor and the STB 702. The audio interface 718 couples the STB 702 to speakers and/or microphones for audio content delivery and receipt. The video camera/video camera interface 716 may include an onboard video camera or may couple the STB 702 to an external video camera. The security processor 720 provides security operations for the STB 702. The STB 702 supports the operations described with reference to FIGS. 1-6B. Client devices previously described herein have structure similar to the STB 702 but may have lesser processing capabilities. In supporting these operations, computer instructions for browser servicing 722, video rendering 724, and video stream servicing 726 may be stored in memory 712.

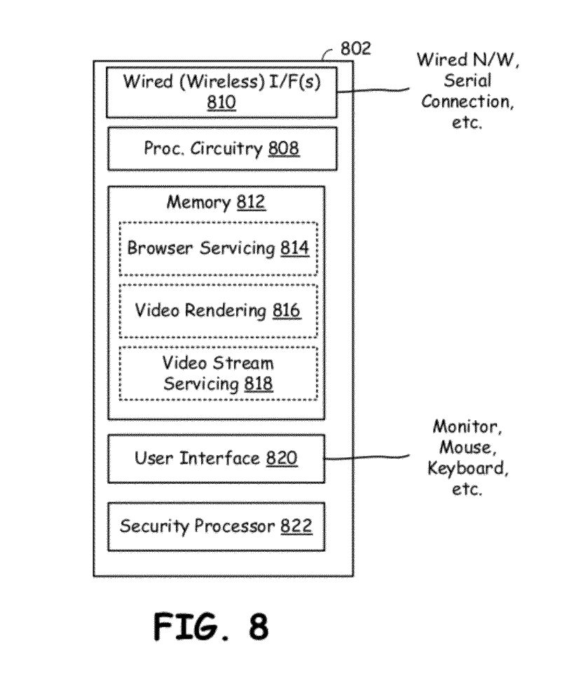

FIG. 8 is a block diagram illustrating a cloud server constructed according to one or more embodiments of the present invention. The cloud server 802 of FIG. 8 includes one or more wired or wireless interfaces 810. Each of these wired or wireless interfaces services data communications via a corresponding communication link. The wired interface may service coaxial communications, optical communications, or another type of wired communication that may provide high throughput for a particular connection. The wireless interface may be a WLAN interface, a satellite interface, a WWAN interface, or another type of wireless interface.

The processing circuitry 808 may include one or more processing units selected from, for example, system processors, reduced instruction set computing processors, digital signal processors, ASICs, custom logic, field programmable gate arrays, or another type of processing device that is capable of executing software instructions and processing digital data. Memory 812 includes one or more of RAM, ROM, DRAM, DROM, optical memory, flash RAM, magnetic memory, or another type of memory capable of storing software instructions and data. User interface 820 interfaces the cloud server to a user via a monitor, a keyboard, mouse, and other types of user input devices. The cloud server may also include a security processor 822 that operates to guarantee that the software on the cloud server 802 is secure and that communications between the cloud server 802 and a remote device are also secure.

According to various embodiments of the present invention, the memory 812 stores specialized computer instructions to service the various operations supported by the cloud server 802. In particular, the memory 812 stores browser servicing instructions 814, video rendering instructions 816, and video stream servicing instructions 818. The browser servicing instructions 814 service an Internet browsing session when the cloud server 802 instantiates a browser to service the Internet browsing needs of one or more serviced client devices. Video rendering instructions 816 allow the cloud server 802 to render video stream representative of a service Internet browsing session. Further, video stream servicing instructions 818 stored in memory 812 allow the cloud server to stream the video representing the browser session instantiated by the cloud server.

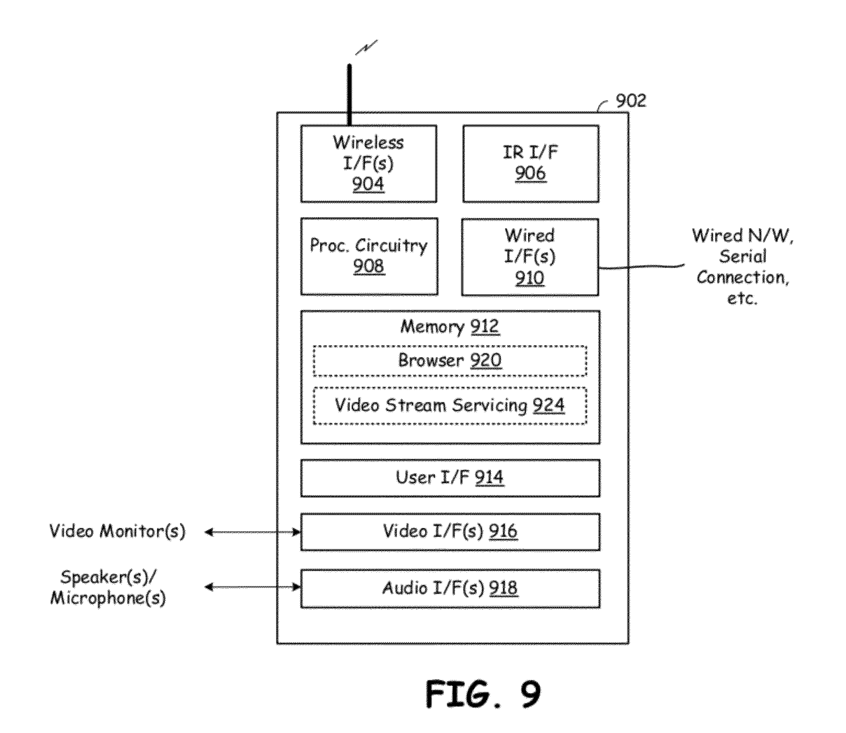

FIG. 9 is a block diagram illustrating a client device constructed according to one or more embodiments of the present invention. A client device 902 of FIG. 9 may be one or more of a laptop computer, desktop computer, notepad computer, digital video player, or another type of device. Thin clients would have fewer resources than would other types of clients that operate according to the present invention. The client device 902 may include a wireless interface 904, an infrared interface 906, and/or one or more wired interfaces 910. The client device 902 includes processing circuitry 908 which includes one or more processors and may include system processors, risk processors, digital signal processors, custom logic, FPGAs, A6, or other types of processing circuitry that are capable of executing software instructions and processing digital data.

Memory 912 may be RAM, ROM, flash RAM, flash ROM, magnetic memory, optical memory, or another type of memory that is capable of storing computer instructions and data. The client device 902 may include one or more user interfaces 914, one or more video interfaces 916, and one or more audio interfaces 918. According to the present invention, the memory 912 stores software instructions that include browser instructions 920 and video stream servicing instructions 924. The browser instructions 920 are those that, when executed, cause the client device 902 to instantiate a browser for an Internet browsing session upon the client device 902. The video stream servicing instructions 924 include instructions capable of receiving a video stream and presenting the video stream to the user via the video interface 916 and the audio interface 918. Further, these instructions 920 and 924 and/or other instructions are capable to allow a user to interface with the client device 902 to provide browsing input via the user interface 914.

The terms “circuit” and “circuitry” as used herein may refer to an independent circuit or to a portion of a multifunctional circuit that performs multiple underlying functions. For example, depending on the embodiment, processing circuitry may be implemented as a single chip processor or as a plurality of processing chips. Likewise, a first circuit and a second circuit may be combined in one embodiment into a single circuit or, in another embodiment, operate independently perhaps in separate chips. The term “chip,” as used herein, refers to an integrated circuit. Circuits and circuitry may comprise general or specific purpose hardware, or may comprise such hardware and associated software such as firmware or object code.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to.” As may even further be used herein, the term “operable to” indicates that an item includes one or more of power connections, input(s), output(s), etc., to perform one or more its corresponding functions and may further include inferred coupling to one or more other items. As may still further be used herein, the term “associated with,” includes direct and/or indirect coupling of separate items and/or one item being embedded within another item. As may be used herein, the term “compares favorably,” indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

1. A method for operating a gateway having at least one communications interface and processing circuitry, the method comprising:
establishing communications with at least one service provider device;
establishing communications with a serviced client device;
receiving serviced client device display structure instructions from a cloud server;
receiving first streamed content from the cloud server, the first streamed content comprising images of an Internet session hosted by the cloud server and having a video program hole formed therein;
receiving second streamed content from the cloud server, the second streamed content comprising a video program corresponding to the video program hole of the first streamed content;
based upon the serviced client device display structure instructions, combining the first streamed content with the second streamed content to form merged streamed content; and
transmitting the merged streamed content to the serviced client device.

2. The method of claim 1, wherein combining the first streamed content with the second streamed content to form the merged streamed content comprises:
decoding the first streamed content;
decoding the second streamed content; and
combining the decoded first streamed content with the decoded second streamed content to produce the merged streamed content.

3. The method of claim 2, further comprising encoding the merged streamed content.

4. The method of claim 2, wherein the first streamed content is encoded according to a first encoding format and the second streamed content is encoded according to a second encoding format that differs from the first encoding content.

5. The method of claim 1, wherein the video program hole of the first streamed content is encoded as a blank portion.

6. The method of claim 1, further comprising:
receiving Internet browsing directions from the client device; and
transmitting the Internet browsing directions to the cloud server, wherein the Internet browsing directions are used by the cloud server to produce the first and second streamed content.

7. A gateway comprising:
at least one communications interface; and
processing circuitry coupled to the at least one communications interface and operable to cause the gateway to:
establish communications with at least one service provider device;
establish communications with a serviced client device;
receive serviced client device display structure instructions from a cloud server;
receive first streamed content from the cloud server, the first streamed content comprising images of an Internet session hosted by the cloud server and having a video program hole formed therein;
receive second streamed content from the cloud server, the second streamed content comprising a video program corresponding to the video program hole of the first streamed content;
based upon the serviced client device display structure instructions, combine the first streamed content with the second streamed content to form merged streamed content; and
transmit the merged streamed content to the serviced client device.

8. The gateway of claim 7, wherein in combining the first streamed content with the second streamed content to form the merged streamed content the processing circuitry is operable to:
decode the first streamed content;
decode the second streamed content; and
combine the decoded first streamed content with the decoded second streamed content to produce the merged streamed content.

9. The gateway of claim 8, wherein the processing circuitry is further operable to encode the merged streamed content.

10. The gateway of claim 8, wherein the first streamed content is encoded according to a first encoding format and the second streamed content is encoded according to a second encoding format that differs from the first encoding content.

11. The gateway of claim 7, wherein the video program hole of the first streamed content is encoded as a blank portion.

12. The gateway of claim 7, wherein the processing circuitry is further operable to:
receive Internet browsing directions from the client device; and
transmit the Internet content directions to the cloud server, wherein the Internet browsing directions are used by the cloud server to produce the first and second streamed content.

13. A method for operating an electronic user device having at least one communications interface, processing circuitry and a user interface having a display, the method comprising:
establishing communications with a gateway;
receiving serviced client device display structure instructions from a cloud server via the gateway;
receiving first streamed content from the cloud server via the gateway, the first streamed content comprising images of an Internet session hosted by the cloud server and having a video program hole formed therein;
receiving second streamed content from the cloud server via the gateway, the second streamed content comprising a video program corresponding to the video program hole of the first streamed content; and
based upon the serviced client device display structure instructions, combining the first streamed content with the second streamed content to form merged streamed content; and
presenting the merged streamed content on the display.

14. The method of claim 13, wherein combining the first streamed content with the second streamed content to form the merged streamed content comprises:
decoding the first streamed content;
decoding the second streamed content; and
combining the decoded first streamed content with the decoded second streamed content to produce the merged streamed content.

15. The method of claim 14, wherein the first streamed content is encoded according to a first encoding format and the second streamed content is encoded according to a second encoding format that differs from the first encoding content.

16. The method of claim 13, wherein the video program hole of the first streamed content is encoded as a blank portion.

17. The method of claim 13, further comprising:
creating Internet browsing directions based upon user input; and
transmitting the Internet browsing directions to the cloud server, wherein the Internet browsing directions are used by the cloud server to produce the first and second streamed content.

18. An electronic user device comprising:
at least one communications interface;
a user interface including a display; and
processing circuitry coupled to the at least one communications interface and to the user interface and operable to cause the electronic user device to:
establish communications with a gateway;
receive serviced client device display structure instructions from a cloud server via the gateway;
receive first streamed content from the cloud server via the gateway, the first streamed content comprising images of an Internet session hosted by the cloud server and having a video program hole formed therein;
receive second streamed content from the cloud server via the gateway, the second streamed content comprising a video program corresponding to the video program hole of the first streamed content; and
based upon the serviced client device display structure instructions, combine the first streamed content with the second streamed content to form merged streamed content; and
present the merged streamed content on the display.

19. The electronic user device of claim 18, wherein combining the first streamed content with the second streamed content to form the merged streamed content comprises:
decoding the first streamed content;
decoding the second streamed content; and
combining the decoded first streamed content with the decoded second streamed content to produce the merged streamed content.

20. The electronic user device of claim 18, wherein the first streamed content is encoded according to a first encoding format and the second streamed content is encoded according to a second encoding format that differs from the first encoding content.

21. The electronic user device of claim 18, wherein the video program hole of the first streamed content is encoded as a blank portion.

22. The electronic user device of claim 13, wherein the processing circuitry is further operable to:
create Internet browsing directions based upon user input; and
transmit the Internet browsing directions to the cloud server, wherein the Internet browsing directions are used by the cloud server to produce the first and second streamed content.
